(19) United States
(12) Patent Application Publication
(10) Pub. No.: US 2011/0114646 A1
(43) Pub. Date: May 19, 2011

(54) DRINKING MUG HAVING A THERMAL HEAT SINK FOR MAINTAINING A BEVERAGE TEMPERATURE

(76) Inventor: Christopher Adam Proskey, Clive, IA (US)

(21) Appl. No.: 12/619,248

(22) Filed: Nov. 16, 2009

(51) Int. Cl. A47J 43/00

(52) U.S. Cl. 220/592.17

(57) ABSTRACT

A drinking mug comprising a bottom having a top surface and a bottom surface, a sidewall connected to the bottom having an exterior surface and an interior surface, having a top end and a bottom end. A beverage area defined by the bottom and sidewall for containing a beverage. A heat sink connected to the bottom having a heat sink top surface and a heat sink bottom surface. The heat sink being made of a material that is denser than the material the bottom and sidewalls are made of.

### BACKGROUND OF THE INVENTION

This invention relates to a drinking mug. More specifically and without limitation, this invention relates to a drinking mug having a thermal heat sink for maintaining a beverage temperature.

### BACKGROUND OF THE INVENTION

Since the dawn of the refrigeration age people have been drinking cool beverages because they are more refreshing than room temperature or warm beverages. This is especially true in warm environments. However, when a cool beverage is poured into a warm drinking mug the drinking mug acts to warm-up the beverage, which reduces the level of refreshment the drinker receives from consuming the beverage, and/or leads to consuming the beverage faster and all the negative affects that follow therefrom.

To overcome these problems many systems and methods have been developed, including: insulated cups and mugs often made of a light-metal, foam and/or plastic material. Although these systems have their advantages, particularly by insulating the beverage, they do not absorb much energy when placed in a refrigerator or freezer. Additionally, these systems do not have the aesthetic properties of a traditional drinking mug made of glass.

Alternatively, ice cubes were developed to place in a beverage to cool it down. Although this method has its advantages, ice cubes melt and dilute the beverage. Additionally, any material, odors or impurities in the ice cube end up in the beverage. To solve this problem plastic covered ice cubes were developed. However, plastic covered ice cubes are not very aesthetically pleasing, and after several iterations of freezing and thawing they tend to break and leak the questionable fluid inside them into the beverage itself. Additionally, due to the absorptive nature of plastic, these plastic ice cubes tend to pick up odors from their environment, such as previous beverages or the freezer in which they are stored, which they then deposit into the beverage.

Alternatively, to ensure that a beverage is not warmed when placed in a drinking mug many drinkers place solid, thick and/or heavy glass drinking mugs in the refrigerator or freezer to make them cool. When it is time to drink the user removes the drinking mug from the freezer or refrigerator and pours the beverage into the cool drinking mug. This method provides the aesthetic benefits of enabling a drinker to drink from a traditional glass drinking mug while not warming the beverage. Additionally, the method does not dilute the beverage or place the risk of disbursing any impurities or contaminates into the beverage. Additionally, the heavier the drinking mug and the cooler the temperature of the drinking mug, the longer the drinking mug will help maintain a cool temperature of the beverage. Additionally, the “frosty-mug” affect is very aesthetic pleasing. This phenomenon occurs when a user removes a drinking mug that is below the freezing temperature of water from a freezer. This causes humidity from the surrounding warm environment to condense on the drinking mug and freeze into a layer of frost which is aesthetically pleasing. Additionally, if the drinking mug is below the freezing temperature of the beverage itself, a layer of beverage will condense into a solid on the inside of the drinking mug which is also aesthetically pleasing.

This method, however, has its disadvantages. First, the thermal properties of glass itself—although somewhat favorable for this method—do not maintain the temperature of the drinking mug for a very long time (i.e., the glass tends to quickly absorb energy from the environment). Therefore, the drinking mug and the beverage tend to warm up quickly and thus the “frosty-mug” affect is unfortunately short-lived.

Despite these advances in maintaining the temperature of a beverage, problems still exist. In particular, problems regarding a drinking mug and method of using said drinking mug that is aesthetically pleasing and maintains the temperature of beverage have not been addressed.

Thus, it is a primary object of the present invention to provide a drinking mug that maintains the temperature of the beverage that improves upon the state of the art.

Another object of the present invention is to provide a drinking mug having a heat sink that helps maintain the temperature of the beverage.

Yet another object of the present invention is to provide a drinking mug having a heat sink that is shielded by an insulting material towards the environment yet unshielded towards the beverage such that thermal preference is given towards maintaining the temperature of a beverage instead of being expelled into the environment.

A further object of the present invention is to provide a drinking mug having a heat sink that extends the longevity of the temperature of a drinking mug over the prior art.

Yet another object of the present invention is to provide a method for achieving the above objectives.

A further object of the present invention is to provide a drinking mug that has a weight in the bottom such that the drinking mug is heavier than conventional drinking mugs and is very appealing especially to many masculine beer consumers.

Yet another object of the present invention is to provide a drinking mug that has a disproportionate amount of weight towards the bottom of the drinking mug (i.e. the bottom of the drinking mug is at least twice as heavy as the top half of the drinking mug) such that the drinking mug has a tendency to stay upright, is well balanced for the drinker and is more difficult to spill accidentally.

It will be appreciated by those skilled in the art that other various modifications could be made to the device without departing from the spirit and scope of this invention. All such modifications and changes fall within the scope of the claims and are intended to be covered thereby.

### BRIEF SUMMARY OF THE INVENTION

A drinking mug comprising a bottom having a top surface and a bottom surface, a sidewall connected to the bottom having an exterior surface and an interior surface, having a top end and a bottom end. A beverage area defined by the bottom and sidewall for containing a beverage. A heat sink connected to the bottom having a heat sink top surface and a heat sink bottom surface. The heat sink being made of a material that is denser than the material the bottom and sidewalls are made of.

### BRIEF DESCRIPTION OF THE DRAWINGS

FIG. 1 is a side view of a drinking mug having a heat sink in the bottom.

FIG. 2 is a side view of a drinking mug having a heat sink having an insulating material.

FIG. 3 is a side view of a drinking mug having a heat sink having a horizontal and vertical portion.

FIG. 4 is a side view of a drinking mug having a heat sink having a horizontal and vertical portion, with a sidewall having a thicker and thinner portion.

FIG. 5 is a side view of a drinking mug having a plurality of unconnected heat sink fingers.

FIG. 6 is a side view of a drinking mug having a heat sink having a plurality of connected heat sink fingers.

FIG. 7 is a side view of a drinking mug having a heat sink having fingers which extend straight upward to a point.

FIG. 8 is a side view of a drinking mug having a heat sink having fingers which extend curvedly upward to an end.

FIG. 9 is a side view of a drinking mug having a heat sink having fingers which get thinner as they extend upward.

FIG. 10 is a side view of a drinking mug having a heat sink in the form of a logo in the sidewall.

FIG. 11 is a top view of a drinking mug having a heat sink in the form of a logo in the bottom.

FIG. 12 is a side view of a drinking mug having a heat sink having threads which is removeably threaded into the bottom.

FIG. 13 is a side view of a drinking mug having a heat sink having a groove which is non-removeably connected to the bottom.

FIG. 14 is a side view of a drinking mug having a heat sink having which is covered on the bottom, sides and part of the top by an insulating material.

FIG. 15 is a side view of a drinking mug having a heat sink having a horizontal and vertical portion which is covered on the bottom and part of the sides by an insulating material.

FIG. 16 is a side view of a drinking mug having a heat sink in the form of a plurality of rings.

### DETAILED DESCRIPTION OF THE PREFERRED EMBODIMENT

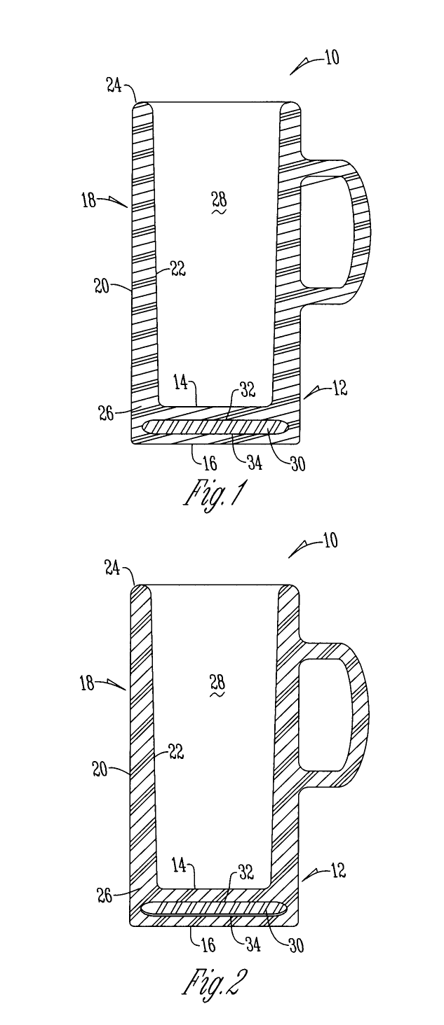

With reference to FIG. 1 a drinking mug 10 has a bottom 12 having a top surface 14 and a bottom surface 16. The drinking mug 10 has a sidewall 18 having an exterior surface 20 and an interior surface 22, and a top open end 24 and a bottom closed end 26. The sidewall 18 extends from the top open end 24 to the bottom closed end 26 where the sidewall 18 is connected to the bottom 12, which defines a hollow interior or beverage area 28 for receiving a beverage. The drinking mug 10 has a heat sink 30 having a heat sink top surface 32 and a heat sink bottom surface 34. The heat sink 30 being made of a material that is denser, heavier and/or has a lower specific heat capacity than the material bottom 12 and the sidewall 18 are made of. The heat sink is contained within the top surface 14 and the bottom surface 16 of the bottom 12. As shown in FIG. 1, the heat sink resides completely within the bottom 12 and is enclosed by the material the drinking mug 10 and/or the bottom 12 are made of. However, the heat sink 30 can likewise reside completely in the sidewall 18. Additionally, in a preferred embodiment the drinking mug 10, including heat sink 30, sidewall 18, and bottom 12 are cylindrical in shape. Additionally, in a preferred embodiment the heat sink 30 is a single piece.

With reference to FIG. 2, the drinking mug 10 has a heat sink 30 having an insulating material 36 on the heat sink bottom surface 34, or a surface facing away from the beverage area 28.

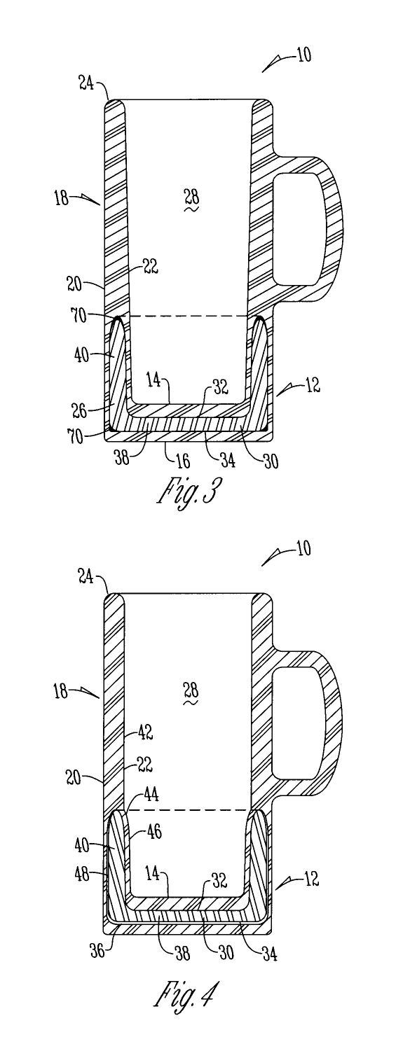

With reference to FIG. 3, the drinking mug 10 has a heat sink 30 having a horizontal portion 38 having a heat sink top surface 32 and a heat sink bottom surface 34 which is contained within the top surface 14 and the bottom surface 16 of the bottom 12. The heat sink 30 of FIG. 3 also has a vertical portion 40 which extends up the drinking mug 10 sidewall 18 which is contained within the exterior surface 20 and the interior surface 22 of the sidewall 18. The heat sink vertical portion 40 is connected at the exterior edge of the heat sink horizontal portion 38.

With reference to FIG. 4, the drinking mug 10 has a heat sink 30 having a horizontal portion 38 and a vertical portion 40. The sidewall 18 of the drinking mug 10 has a thin portion 42 where the sidewall 18 does not cover the vertical portion 40 of the heat sink 30, a thick portion 46 where the sidewall 18 covers the vertical portion 40 of heat sink 30, and a transition portion 44 between the thin portion 42 and the thick portion 46. In an alternative embodiment, as shown in FIG. 3, the sidewall 18 of the drinking mug 10 is of a constant thickness regardless if the sidewall 18 is covering the vertical portion 40 of heat sink 30. Additionally, FIG. 4 shows the insulating material 36 on the heat sink exterior surface 48 of the vertical portion 40 of heat sink 30 as well as on the heat sink bottom surface 34.

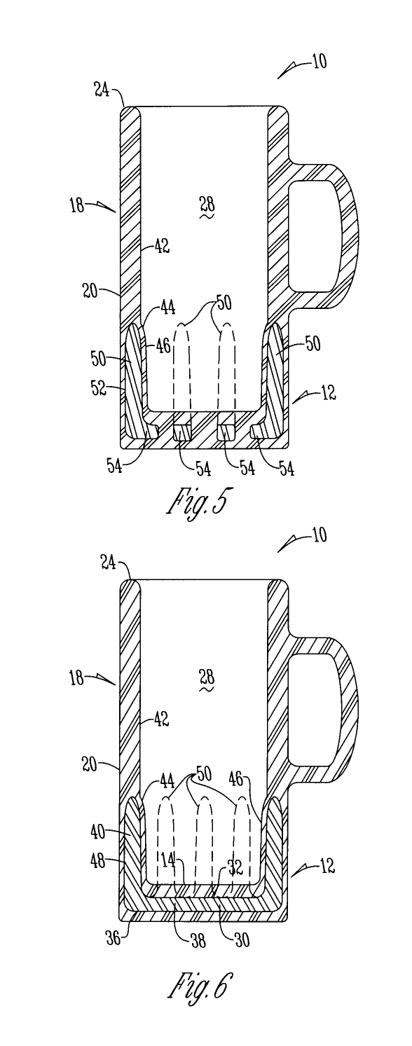

With reference to FIG. 5, the drinking mug 10 has a plurality of heat sink fingers 50. Fingers 50 have a finger bottom portion 54 which resides in bottom 12 of drinking mug 10 and finger vertical portion 52 which resides in sidewall 18 of drinking mug 10. Alternatively, heat sink fingers 50 reside entirely in the sidewall 18 of drinking mug 10, or entirely in the bottom 12 of drinking mug 10.

With reference to FIG. 6, the drinking mug 10 has a heat sink 30 with a horizontal portion 38 contained within the bottom 12 of drinking mug 10. Connected at the exterior edge of the heat sink horizontal portion 38 are a plurality of fingers 50 which extend upwardly from the horizontal portion 38 of heat sink 30 in sidewall 18 of drinking mug 10.

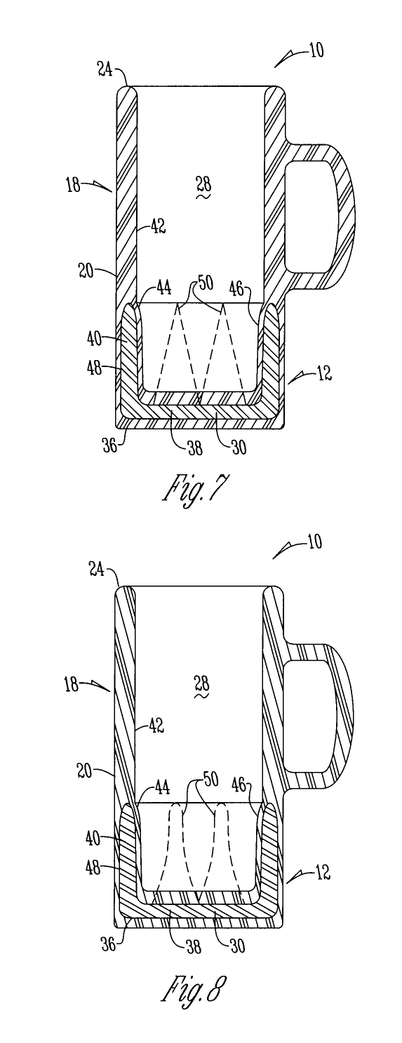

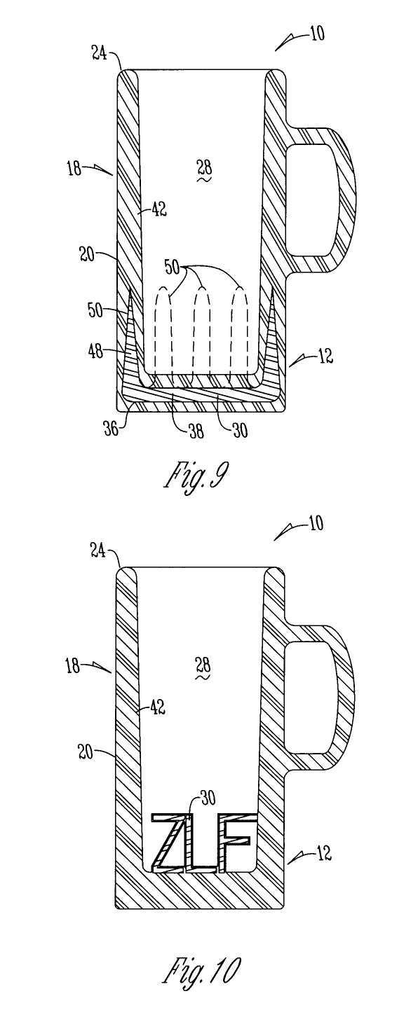

With reference to FIG. 7, the drinking mug 10 has heat sink 30 with horizontal portion 38 connected to a plurality of fingers 50 which extend upwardly at an angle in a straight fashion to a point. Similarly, with reference to FIG. 8, the drinking mug 10 has a heat sink 30 with a horizontal portion 38 connected to a plurality of fingers 50 which extend upwardly in a curved fashion to an end. Additionally, the heat sink may take on many different forms and aesthetic designs and still achieve the same objectives. Similarly, with reference to FIG. 9, as the plurality of fingers 50 extends upwardly the mass of the heat sink material decreases, i.e., they get thinner within the sidewall 18.

With reference to FIGS. 7, 8 and 9, as fingers 50 extend upwardly the amount of heat sink material lessens, i.e., the higher the fingers 50 extend the less heat sink 30 material is present. This reduction of heat sink material as you go up, or increase in heat sink material as you go down, is to facilitate proper cooling of the beverage and balance of the drinking mug 10.

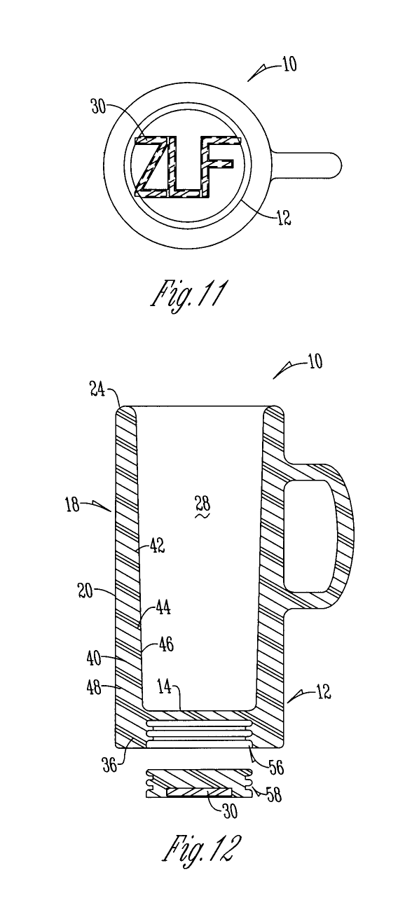

With reference to FIGS. 10 and 11, the heat sink 30 takes the form of a logo, any logo. The logo may be in the form of letters, a name, an emblem, a design. In FIG. 10 the logo resides in the sidewall 18 of drinking mug 10. In FIG. 11 the heat sink 30 logo resides in the bottom 12 of drinking mug 10. Alternatively, the heat sink 30 contains a logo.

Alternatively, the logo is attached to the heat sink 30, etched into the heat sink 30, painted onto the heat sink 30, or placed on or by the heat sink 30 in any other way as known in the art.

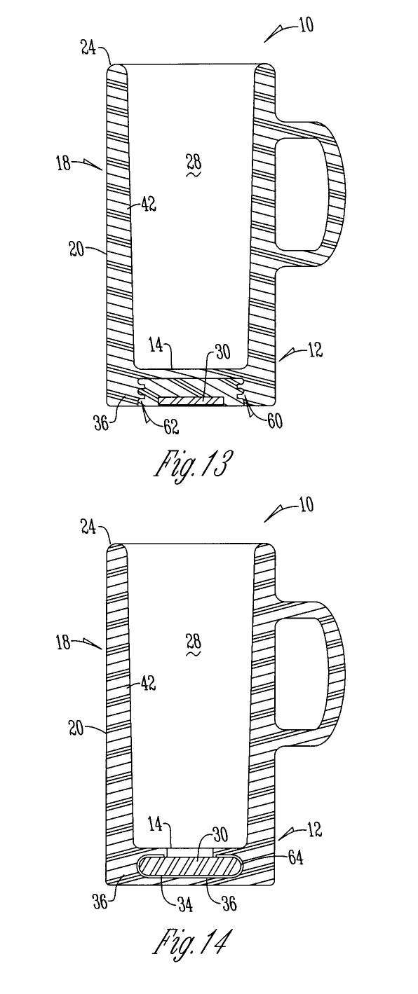

In an alternative embodiment, with reference to FIG. 12, a drinking mug 10 has a bottom 12 having a plurality of threads 56. Correspondingly, heat sink 30 has a plurality of heat sink threads 58 such that the heat sink 30 can be removeably threaded into the bottom 12 of drinking mug 10. Alternatively, with reference to FIG. 13 a drinking mug 10 has bottom 12 having at least one groove 60 or flange. Correspondingly, heat sink 30 has at least one grove 62 such that heat sink 30 and bottom 12 matingly receive one another in a non-removable fashion.

With reference to FIG. 14, heat sink 30 has an insulting material 36 covering the heat sink bottom surface 34 and the heat sink side surface 64 and partially covering the heat sink top surface 32. In this embodiment the heat sink top surface 32 has a non insulated portion.

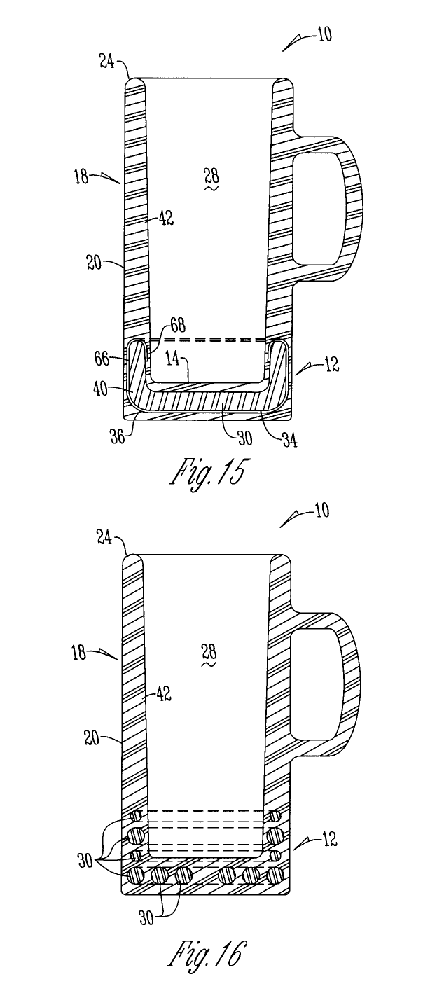

Similarly, with reference to FIG. 15, heat sink 30 has an insulating material 36 covering the heat sink bottom surface 34 and the exterior surface 66 of the vertical portion 40 of heat sink 30. This insulating material can extend over the top of the vertical portion 40 of heat sink 30 and partially down the inside surface 68 of the vertical portion 40 of heat sink 30.

With reference to FIG. 16, the heat sink 30 takes the form of a plurality of rings of heat sink material. These rings reside entirely within the sidewall 18, entirely within the bottom 12, or both within the sidewall 18 and the bottom 12. These rings may extend parallel to the bottom 12 or at an angle to the bottom 12.

The heat sink 30 is made of a material that has favorable thermal properties such that when the drinking mug 10 is placed in a refrigerator or freezer the drinking mug material and the heat sink material release their heat energy to the cooler surroundings in the refrigerator or freezer. However, because of the favorable thermal properties of the heat sink material, the heat sink 30 releases more energy than the drinking mug material. Many materials can be used that release more energy than the drinking mug material.

The Second Law of Thermodynamics says that heat will spontaneously flow from a hot object to a cooler one, such that the drinking mug releases its heat energy to the cooler surroundings in the refrigerator or freezer. The specific heat capacity is a constant of proportionality for a particular material that tells how much heat energy it takes to change the temperature of the substance.

For example, lead has a heat capacity of 26.6 J/(mol K). Therefore, to raise the temperature of 1 mol (207 g) of lead by one degree kelvin, 26.6 J of heat energy would have to be put into the material.

On the other hand, the heat capacity of most glasses is around 50 J/(mol K), therefore to raise the temperature of the same mass of glass (207 g=3.45 mol) by one degree kelvin, (3.45 mol SiO2) (50 J/(mol K)) (1 K)=173 J of heat energy would have to be put in.

In operation, the heat sink material loses less heat energy than the drinking mug material because of the specific heat capacity properties of the two materials.

When the drinking mug 10 is removed from the refrigerator or freezer, both the heat sink material and the drinking mug material are the same (low) temperature. When a beverage (liquid) is poured into the drinking mug 10, the beverage is insulated by the drinking mug material, but since the heat sink material will accept heat more “easily” because of its lower heat capacity, the drinking mug material itself is kept cooler by the presence of the heat sink material. If the drinking mug material stays cooler, then the liquid will stay cooler longer as well.

It's not at all unlike the observation that climates are more temperate near large bodies of water. The water changes temperature much more slowly than the ground because the water has a higher heat capacity (it takes more heat energy to change the temperature of water). The ground changes temperature faster, because it takes less heat to change its temperature (i.e. it has a lower heat capacity). In such a case, the water keeps the ground warmer or cooler than it would otherwise be.

For example, and without limitation, if the drinking mug 10 is made out of a glass material the heat sink 30 could be made of lead or a metal alloy that absorbs more energy than the glass material. This arrangement, as an example, would achieve the above stated objectives.

A heat sink material should also be chosen based on its thermal expansion coefficient such that the thermal expansion coefficient of the glass material should be compatible with the thermal expansion coefficient of the heat sink material. That is, through the iterative process of cooling and warming of the drinking mug 10, the glass material and the heat sink material will contract and expand differently. To minimize this, two materials should be chosen that are compatible, such that internal stresses are limited. Additionally, to assist in limiting these internal stresses, specific geometries of the heat sink 30 should be chosen to limit the effect of heat sink expansion and contraction within the glass material. Also, the heat sink 30 and drinking mug 10 can be tempered or heat treated to limit these stresses. Also, a buffering material 70 can be placed around the heat sink 30 or at least in the necessary places to buffer the affects of the varying expansion and contraction of the drinking mug material and the heat sink material. Buffering material 70 can be of any compressible material that can absorb the expansion and contraction forces of drinking mug 10 See, for example, FIG. 3 where buffering material 70 is placed at the top of the vertical portion 40 of the heat sink 30 and the exterior bottom edge of the horizontal portion 38 of heat sink 30. Alternatively, the buffering material 70 completely surrounds a surface of the heat sink 30, or the entire heat sink 30. The buffering material can be made of any compressible material.

In operation, a user takes a room temperature drinking mug 10 having a heat sink 30 and places it in a freezer or refrigerator, (in this example, a freezer). The drinking mug 10 and heat sink 30 release their heat energy to the freezer. The drinking mug material releases energy to the freezer but the heat sink material releases a considerably greater amount of energy due to the favorable thermal properties of the heat sink material. When the drinking mug 10 and heat sink 30 has reached the ambient temperature of the freezer the user removes the drinking mug 10 from the freezer and pours a beverage into the beverage area 28. The cool (in comparison to the environment) drinking mug 10 and heat sink 30 absorb energy from the beverage. However, due to the thermal properties of the heat sink material the heat sink 30 absorbs more energy from the beverage than the drinking mug material. If the heat sink 30 has an insulating material 36 on the surface facing the environment then the heat sink is shielded from the warm environment such that the heat sink 30 receives more heat energy from the beverage and not the surrounding environment. In this way the drinking mug 10 having a heat sink 30 maintains a beverage temperature better and longer than the prior art glasses.

Accordingly, the drinking mug 10 having a thermal heat sink described herein offers many advantages over the prior art including providing an aesthetically pleasing drinking mug which maintains the temperature of a beverage better than the prior art.

In another embodiment, with reference to FIG. 12, a single annular groove 56, or a plurality of grooves or notches 56 are located in the bottom 12 of the drinking glass 10. In this embodiment the drinking glass 10 is made of a glass or another first material. After the drinking glass 10 is created, a heat sink 30 is placed in the bottom 10 of the drinking glass. Once the heat sink 30 is in place, a liquid material or binder or second material is poured into the bottom 12 of the drinking glass 10 to fill the remaining area, space or depression in the bottom of the drinking glass 10. Once this liquid hardens it seals and locks the heat sink 30 in place because the liquid material or binder fills the grooves 56 and thereby cannot come out the bottom of the drinking glass 10. This liquid material or binder also acts as an insulating material thereby directing the energy into the bottom 12 of the drinking glass 10 and shielding the surrounding environment. In this arrangement, the drinking glass can be made of glass whereas the liquid material or binder can be an acrylic material or any other material that can flow in a liquid state and solidify in a solid state thereby locking the heat sink 30 in place. Alternatively the material the drinking glass 10 and the liquid material or binder are made from the same material.

It will be appreciated by those skilled in the art that other various modifications could be made to the device without parting from the spirit and scope of this invention. All such modifications and changes fall within the scope of the claims and are intended to be covered thereby.

What is claimed is:

1. A drinking mug assembly comprising:
a bottom having a top surface and a bottom surface;
a sidewall connected to the bottom having an exterior surface and an interior surface, having a top end and a bottom end;
a beverage area defined by the bottom and sidewall for containing a beverage; and
a heat sink connected to the bottom having a heat sink top surface and a heat sink bottom surface.

2. The drinking mug as described in claim 1 further comprising: the heat sink being made of a material having a lower specific heat capacity than the material the bottom and sidewalls are made of.

3. The drinking mug as described in claim 1 further comprising: the heat sink being made of a material having a higher density than the material the bottom and sidewalls are made of.

4. The drinking mug as described in claim 1 further comprising: the heat sink being made of a material that is heavier than the material the bottom and sidewalls are made of.

5. The drinking mug as described in claim 1 further comprising: the heat sink being contained within the top surface and the bottom surface of the bottom.

6. The drinking mug as described in claim 1 further comprising: the heat sink extending up the sidewall within the exterior surface and interior surface of the sidewall.

7. The drinking mug as described in claim 1 further comprising: the heat sink being cylindrical in shape.

8. The drinking mug as described in claim 1 further comprising: the heat sink being a single piece.

9. The drinking mug as described in claim 1 further comprising: the heat sink being a plurality of pieces.

10. The drinking mug as described in claim 1 further comprising: the heat sink having a cylindrical bottom and a sidewall extending away from the bottom.

11. The drinking mug as described in claim 1 further comprising: the heat sink having a plurality of fingers.

12. The drinking mug as described in claim 1 further comprising: the heat sink containing a logo.

13. The drinking mug as described in claim 1 further comprising: the heat sink being in the shape of a logo

14. The drinking mug as described in claim 1 further comprising: the heat sink having an insulating material on a surface facing away from the beverage area.

15. The drinking mug as described in claim 1 further comprising: the heat sink having an insulating material on the bottom of the heat sink.

16. The drinking mug as described in claim 1 further comprising: the heat sink being made of a material from the group consisting of metal, metal alloy, rock, stone and composite.

17. The drinking mug as described in claim 1 further comprising: the bottom and sidewall being made of a glass material.

18. The drinking mug as described in claim 1 further comprising: the bottom and sidewall being made of a glass material that is heat treated.

19. A drinking mug assembly comprising:
a bottom having a top surface and a bottom surface;
a sidewall connected to the bottom having an exterior surface and an interior surface having a top end and a bottom end;
the bottom and sidewall being made of a glass material;
a beverage area defined by the bottom and sidewall for containing a beverage;
a heat sink connected to the bottom having a heat sink top surface and a heat sink bottom surface; and
the heat sink being made of a material that is heavier and absorbs more energy than the material the bottom and sidewalls are made of.

20. A mug assembly for maintaining a beverage temperature comprising:
a bottom made of a material having a first heat coefficient;
a sidewall extending from the bottom to an open top end and surrounding a hollow interior that receives a beverage;
a heat sink disposed within the bottom and having a second heat coefficient which is lower than the first heat coefficient.
